(19) United States
(12) Patent Application Publication
(10) Pub. No.: US 2026/0236540 A1
(43) Pub. Date: Aug. 13, 2026

(54) METHODS AND SYSTEMS FOR GENERATING A DIGITAL DOCUMENT

(71) Applicant: CANADIAN IMPERIAL BANK OF COMMERCE (CIBC), Toronto (CA)

(72) Inventors: Charles Eric METIVIER, Toronto (CA); Lihor ABRAHAM, Toronto (CA); Bencheng WEI, Toronto (CA); Christopher ROHOMAN, Toronto (CA); Atinder SAINI, Toronto (CA)

(21) Appl. No.: 19/637,206

(22) Filed: Apr. 2, 2026

Related U.S. Application Data
(60) Provisional application No. 63/945,178, filed on Dec. 19, 2025.

(51) Int. Cl. G06F 16/93; G06F 16/22; G06F 16/2457; G06F 18/241

(52) U.S. Cl. CPC G06F 16/93; G06F 16/2237; G06F 16/24578; G06F 18/241

(57) ABSTRACT

Systems and methods for generating a digital document with a defined structure are disclosed. The method involves receiving a data structure defining document segments, maintaining a classification model configured to classify particular documents for relevance to particular document segments, receiving source documents, associating a class label with each source document using the classification model, storing in a vector database, embeddings corresponding to the source documents, in accordance with their associated class labels, for each query for information relevant to a given document segment, submitting that query to the vector database to obtain search results from among those embeddings with class labels indicating relevance to the given document segment, constructing input instructions including the search results for a language generation model to generate textual content for the given document segment, and generating the digital document using outputs of the language generation model. The digital document is structured to include the document segments.

### CROSS-REFERENCE TO RELATED APPLICATIONS

This application claims all benefit, including priority to, U.S. Provisional Patent Application 63/945,178, filed Dec. 19, 2025, and entitled “METHODS AND SYSTEMS FOR GENERATING A DIGITAL DOCUMENT”; the entire content of which is incorporated by reference herein.

### FIELD

The present disclosure generally relates to the field of computer-aided document generation and in particular to generating a digital document with a defined structure.

### BACKGROUND

In many industries, reports serve an important role in supporting decision-making and ensuring compliance. For example, a report may summarize a company's financial position when applying for a loan or outline governance principles when seeking investment. Traditionally, these reports are prepared manually by associates or analysts who gather data from multiple sources, review the information, and synthesize it into a cohesive document.

This manual process is time-consuming, susceptible to human error, and often results in inconsistencies between reports. Furthermore, these reports typically require a high degree of trust in the individuals preparing them, as they frequently lack transparency and auditability.

### SUMMARY

In accordance with an aspect, there is provided a computer-implemented system for generating a digital document with a defined structure. The system includes: a data communication subsystem that includes one or more network interfaces for receiving data by way of one or more data networks and a processing subsystem that includes one or more processors and one or more memories coupled with the one or more processors. The processing subsystem is configured to cause the system to: receive a data structure defining a plurality of document segments; maintain a classification model configured to classify particular documents for relevance to particular document segments; receive a plurality of source documents, including by way of the data communication subsystem; associate at least one class label with each of the source documents using the classification model, the class label indicating relevance to a particular document segment; store in a vector database, a plurality of embeddings corresponding to the source documents, in accordance with their associated class labels. For each of a plurality of queries for information relevant to a given document segment of the plurality of document segments, the processing subsystem is configured to cause the system to: submit that query to the vector database to obtain a plurality of search results from among those embeddings with class labels indicating relevance to the given document segment; construct input instructions for a language generation model to generate textual content for the given document segment, the input instructions including the search results; and generate the digital document using a plurality of outputs of the language generation model, the document structured to include the plurality of document segments.

In some embodiments, the textual content for the given document segment includes one or more citations identifying the one or more source documents associated with the search results and the processing subsystem is configured to cause the system to: for each segment of the generated document, retrieve the one or more identified source documents based on the one or more class labels; and validate the textual content of the given document segment against the one or more identified source documents using a validation model.

In some embodiments, the processing subsystem is configured to cause the system to: divide a segment of the generated document into a plurality of sub-segments; for each sub-segment, determine a sub-segment validation result; and determine a segment validation result for the segment based on the sub-segment validation results of each of the plurality of sub-segments.

In some embodiments, the classification model classifies a given source document based on at least one of a content of the source document or metadata associated with the source document.

In some embodiments, the input instructions include a class label priority and the language generation model is configured to prioritize the search results associated with the class labels indicated by the class label priority when generating textual content for the given document segment.

In some embodiments, the processing subsystem is configured to cause the system to receive an input indicating a type of digital document being generated and select the data structure associated with the type of document from a plurality of data structures.

In some embodiments, the processing subsystem is configured to cause the system to retrieve the plurality of queries based on the type of digital document generated.

In some embodiments, the processing subsystem is configured to cause the system to retrieve historical documents; determine a historical structure for the textual content for the given document segment based on the historical documents; and the input instructions include the historical structure.

In some embodiments, the processing subsystem is configured to cause the system to identify that one or more portions of a given source document is associated with non-substantive content based on a semantic comparison between the given source document and example non-substantive content; remove, from the given source document, the identified one or more portions to obtain a preprocessed source document; and store in the vector database, the one or more embeddings corresponding to the preprocessed source document.

In some embodiments, the processing subsystem is configured to cause the system to search one or more publicly available databases to obtain one or more supplementary search results; and the input instructions include the supplementary search results.

In some embodiments, the processing subsystem is configured to cause the system to: receive a feedback input from a user device in communication with the system; identify one or more segments of the digital document associated with the feedback input; in response to receiving the feedback input, generate one or more updated input instructions based in part on the feedback input; receive, from the language generation model, one or more updated outputs generated in response to the one or more updated input instructions; and generate an updated digital document based on the one or more updated outputs.

In some embodiments, the processing subsystem is configured to cause the system to maintain a chatbot, and the feedback input is received via the chatbot.

In some embodiments, the processing subsystem is configured to cause the system to divide at least one source document of the plurality of source documents into a plurality of data chunks, and to associate a class label with each of the data chunks using the classification model.

In accordance with another aspect, there is provided a computer-implemented method for generating a digital document with a defined structure. The method includes: receiving a data structure defining a plurality of document segments; maintaining a classification model configured to classify particular documents for relevance to particular document segments; receiving a plurality of source documents, including by way of a data communication subsystem; associating at least one class label with each of the source documents using the classification model, the class label indicating relevance to a particular document segment; storing in a vector database, a plurality of embeddings corresponding to the source documents, in accordance with their associated class labels. For each of a plurality of queries for information relevant to a given document segment of the plurality of document segments, the method involves: submitting that query to the vector database to obtain a plurality of search results from among those embeddings with class labels indicating relevance to the given document segment; constructing input instructions for a language generation model to generate textual content for the given document segment, the input instructions including the search results; and generating the digital document using a plurality of outputs of the language generation model, the document structured to include the plurality of document segments.

In some embodiments, the textual content for the given document segment includes one or more citations identifying the one or more source documents associated with the search results and the method further involves: for each segment of the generated document, retrieving the one or more identified source documents based on the one or more class labels; and validating the textual content of the given document segment against the one or more identified source documents using a validation model.

In some embodiments, the method involves: dividing each segment of the generated document into a plurality of sub-segments; for each sub-segment, determining a sub-segment validation result; and determining a segment validation result for the segment based on the sub-segment validation result of each of the plurality of sub-segments.

In some embodiments, the classification model is configured to classify a given source document based on at least one of a content of the source document or metadata associated with the source document.

In some embodiments, the input instructions include a class label priority and the language generation model is configured to prioritize the search results associated with the class labels indicated by the class label priority when generating textual content for the given document segment.

In some embodiments, the method involves receiving an input indicating a type of digital document being generated and selecting the data structure associated with the type of document from a plurality of data structures.

In some embodiments, the method involves retrieving the plurality of queries based on the type of digital document generated.

In some embodiments, the method involves: retrieving historical documents; determining a historical structure for the textual content for the given document segment based on the historical documents, and the input instructions include the historical structure.

In some embodiments, the method involves identifying that one or more portions of a given source document is associated with non-substantive content based on a semantic comparison between the given source document and example non-substantive content; removing, from the given document, the identified one or more portions to generate a preprocessed source document; and storing in the vector database, one or more embeddings corresponding to the preprocessed source document.

In some embodiments, the method involves searching one or more public databases to obtain one or more supplementary search results; and the input instructions include the supplementary search results.

In some embodiments, the method involves receiving a feedback input via a network from a user device; identifying one or more segments of the digital document associated with the feedback input; in response to receiving the feedback input, generating one or more updated input instructions based in part on the feedback input; receiving, from the language generation model, one or more updated outputs generated in response to the one or more updated input instructions; and generating an updated digital document based on the one or more updated outputs.

In some embodiments, the method involves maintaining a chatbot and receiving the feedback input via the chatbot.

Many further features and combinations thereof concerning embodiments described herein will appear to those skilled in the art following a reading of the instant disclosure.

### BRIEF DESCRIPTION OF THE DRAWINGS

In the figures,

FIG. 1 is a block diagram of a digital document generation system in communication with external components, in accordance with an embodiment;

FIG. 2A is a block diagram of an example digital document generation system, in accordance with an embodiment;

FIG. 2B is a block diagram of the preprocessor of the digital document generation system, in accordance with an embodiment;

FIG. 3 shows an example vector database of a digital document generation system, in accordance with an embodiment;

FIG. 4 is a diagram representation of an operation of a classifier used for associating class labels to source documents, in accordance with an embodiment;

FIG. 5 is a flowchart of a method for generating a digital document, in accordance with an embodiment;

FIG. 6 is a pictorial representation of an example method of generating a digital document, in accordance with an embodiment;

FIG. 7A is an example data structure that may be received by a digital document generation system, in accordance with an embodiment;

FIG. 7B is another example data structure that may be received by a digital document generation system, in accordance with an embodiment;

FIG. 8 shows example queries that may be used by a digital document generation system for obtaining search results, in accordance with an embodiment;

FIG. 9A is an example document that may be generated by a digital document generation system;

FIG. 9B is another example document that may be generated by a digital document generation system;

FIG. 10 shows example instructions that may be constructed by a digital document generation system; and

FIG. 11 is a schematic diagram of a computing device that may be used to implement functionalities disclosed herein, in accordance with an embodiment.

These drawings depict exemplary embodiments for illustrative purposes, and variations, alternative configurations, alternative components and modifications may be made to these exemplary embodiments.

### DETAILED DESCRIPTION

Disclosed herein are embodiments of systems and methods for generating a digital document with a defined structure using source documents. The embodiments disclosed can generate textual content for various types of digital documents, for example, digital documents that are used for assessing a person's (including a company) performance and practices, such as credit narrative reports, term sheets, regulatory responses, mergers and acquisitions diligence reports, internal audits, know-your-client reports, anti-money-laundering reports, vendor risk reports, contracts, and environment, social, and governance (ESG) reports.

For example, a credit narrative report is a written summary that outlines a borrower's financial health and business viability that can be used as part of a credit decision, such as approving or declining a loan or credit facility. A credit narrative typically outlines a borrower's financial position, repayment capacity, business performance, and any mitigating factors for risks identified. The use of credit narratives can enhance transparency, consistency, and compliance in the credit approval process.

As another example, an ESG report is a document that outlines a company's performance and practices related to sustainability, social responsibility, and ethical governance. It typically includes metrics and narratives on areas such as carbon emissions, resource usage, employee well-being, diversity and inclusion, community impact, and corporate governance standards. ESG reports are typically provided to stakeholders such as investors, regulators, and customers to attract investment and align with regulatory or industry sustainability frameworks.

Conventionally, preparing these documents involves associates/analysts dedicating significant time and effort to research and data gathering. The process typically involves associates/analysts collecting and reviewing documents from multiple sources, such as internal documents, financial statements, regulatory guidelines, and market analyses, and then synthesizing the information in these documents into a report format. Because the data is scattered across various systems and files, these individuals can spend several days and up to a week to consolidate the information and prepare reports. As a result, report preparation can be both time-consuming and resource-intensive.

In addition, due to differences in experience, skill and writing styles, there can be significant discrepancies between reports prepared, even within an organization.

The disclosed embodiments can automatically generate a digital document having a defined structure based on source documents, by searching for information relevant to generating the digital document in the source documents, reducing the time needed for preparing digital documents. The disclosed embodiments can generate a digital document by segmenting the digital document and generating textual content for the different segments of the digital document.

The embodiments disclosed can employ a language generation model that includes one or more large language models (LLMs) to generate outputs that can then be used to generate a digital document. By employing LLMs, the disclosed embodiments can generate digital documents that can be understood by humans and that are similar in scope to documents conventionally prepared by associates/analysts.

The embodiments disclosed can employ retrieval-augmented generation (RAG) to improve the performance of the LLM(s) by providing information determined to be relevant to a particular segment of a document being generated to the LLM(s). By providing information specific to a particular document segment to the LLM(s), the LLMs can generate more accurate outputs.

The disclosed embodiments involve associating class labels with source documents used to generate a digital document and generating the digital document with reference to those class labels. As will be explained in further detail below, class labels can indicate a document's relevance to specific document segments of the digital document being generated. When generating textual content for a given document segment, the embodiments disclosed can search for relevant information by limiting the search to documents associated with the corresponding class labels. Constraining the search space can enable faster retrieval of relevant search results, improve the quality (e.g., relevance) of the search results, and reduce computational resources needed for performing the search. Further, by associating class labels indicating relevance to specific document segments, the embodiments disclosed can obtain different search results for different segments, improving the relevance of the search results obtained for each segment.

Further, by identifying search results relevant to generating the textual content of a document segment and providing those search results to the language generation model, the disclosed embodiments can supplement the language generation model's internal parameters to generate an output of a higher quality, when compared to models that do not involve augmenting a model's internal parameters with a particular set of search results, and reduce the model's risk of hallucinations, by grounding the model's responses in information from source documents.

Further, associating class labels to source documents can enable source documents relevant to a particular segment of a digital document to be segregated from source documents that may not be relevant, enabling the language generation model to focus on source documents that are relevant to the particular segment being generated. In some cases, different source documents may be relevant to different segments of a digital document. By associating class labels that indicate a source document's relevance to a given document segment, the embodiments disclosed can generate segments of a digital document based on different sets of source documents, resulting in more accurate content generated and reducing the risk of content that may not be relevant being included in a digital document.

In addition, classification can enable flexible prioritization of different source documents. Depending on the domain (e.g., banking, mining, project financing, etc.) to which a digital document relates, different source documents may be relevant for generating the digital document. By associating classification labels to source documents and prioritizing different class labels according to the domain, the embodiments disclosed can prioritize different source documents depending on the digital documents generated, enhancing their accuracy.

At least some of the embodiments disclosed involve validating a digital document generated and identifying portions of a digital document that may include incorrect information (e.g., hallucinated information), enabling a digital document's factuality and accuracy to be more easily assessed.

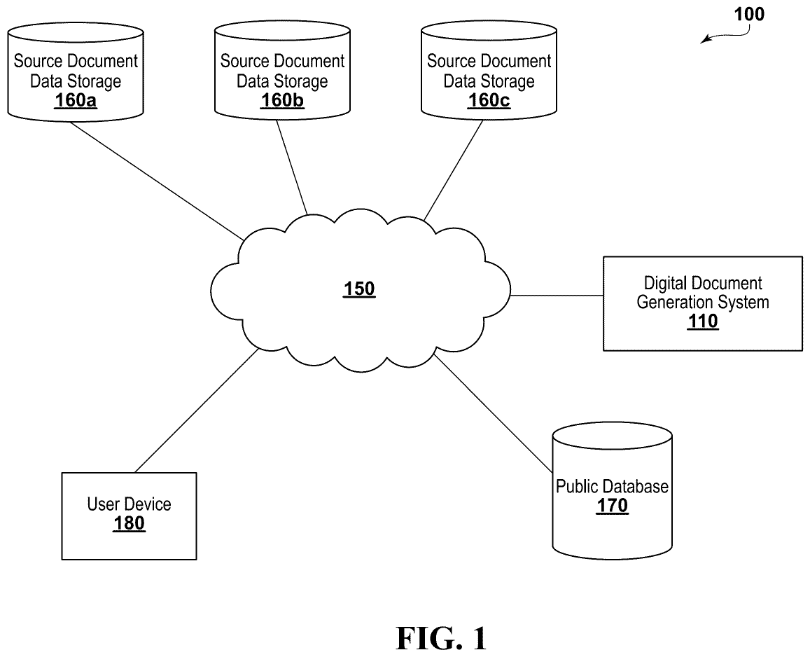

Reference is first made to FIG. 1 which shows a block diagram 100 of a digital document generation system 110 in communication with a user device 180, one or more source document data storages 160a-160c and public databases 170 via a network 150.

The digital document generation system 110 is configured to generate digital documents based on source documents. The digital document generation system 110 can be configured to generate any type of digital document that involves synthesizing information from multiple source documents. For example, the digital document generation system 110 can generate credit narrative reports, term sheets, and environmental, social and governance (ESG) reports. The digital document generation system 110 can generate digital documents based on source documents stored in the source document data storage 160 and other data sources.

The digital document generation system 110 can transmit and receive various data via the network 150 that may be used for generating a digital document and/or validating a digital document generated, including, but not limited to, a data structure defining document segments for a digital document to be generated, source documents used for generating a digital document, inputs indicating a type of document to be generated, queries for information relevant to a digital document to be generated, feedback input, historical documents, outputs from a language generation model and/or a digital document generated.

User device 180 can include any networked device that is capable of connecting to network 150 and of communicating with the digital document generation system 110 via the network 150. Though only one user device 180 is shown, multiple user devices 180 may be in communication with the digital document generation system 110. Each user device 180 may be associated with a user or a group of users (e.g., an organization).

The user device 180 may include at least a processor and memory, and may be an electronic tablet device, a personal computer, workstation, server, portable computer, mobile device, laptop, smart phone, and portable electronic devices or any combination of these that enables a user to interact with the digital document generation system 110.

For example, a user may interact with a graphical user interface (GUI) of the user device 180 to select source documents for consideration by the digital document generation system 110, select a type of digital document to be generated, receive a digital document generated by the digital document generation system 110, provide feedback in response to a digital document generated by the digital document generation system 110, etc.

Each source document data storage 160 can include one or more databases for storing source documents that may be used for generating a digital document by the digital document generation system 110. Though three source document data storages 160a-160c are shown, the digital document generation system 110 can be in communication with any number of source document data storages 160. For example, there can be more source document data storages 160, or fewer source document data storages. In cases where there are fewer source document data storages, each source document data storage may store documents originating from various sources (i.e., documents from different sources can be collected into the source document data storage 160).

Source documents can include any document that includes text, images and/or tables that may be relevant to a digital document being generated by the digital document generation system 110. Source documents can include documents manually prepared, documents prepared by the digital document generation system and/or documents prepared by external systems for generating digital documents.

Example source documents for generating a credit narrative report can include, but are not limited to, an annual report, an annual information form, a management's discussion and analysis (MD&A) report, financial statements, investor day reports, investor presentations, earnings call transcripts, earnings presentations, a monthly operating report, a consolidated equity research report, a CEO succession plan, company notes on impact from recent news, a report of a company's future goals, an equity research report, a previous credit narrative, reports prepared by credit rating agencies, and documents generated by the digital document generation system 110. The type of source document stored in a source document data storage 160 can vary depending on the specific application of the digital document generation system 110.

In at least some embodiments, each source document data storage 160 includes a plurality of databases. For example, different source documents may be prepared by different teams within an organization, which may store the source documents in different databases.

Source documents stored in the source document data storage 160 can be retrieved by the digital document generation system 110 via the network 150.

In some embodiments, each source document data storage 160 stores a different type of data. For example, a first source document data storage 160 can store historical source documents (e.g., source documents prepared or generated in the past); a second source document data storage 160 can store source documents prepared in near real time.

In some embodiments, each source document data storage 160 is associated with a data source (e.g., a team within an organization, an application or program, etc.).

Public database 170 can include a plurality of databases that include information that is publicly available; for example, public database 170 can include databases hosted on web servers and accessible by querying the internet.

Network 150 can include any type of network capable of carrying data, including the Internet, mobile, wireless, a wide area network, a local area network, and others, including any combination of these, capable of interfacing with, and enabling communication between the digital document generation system 110, the user device(s) 180, the source document data storages 160 and the public databases 170.

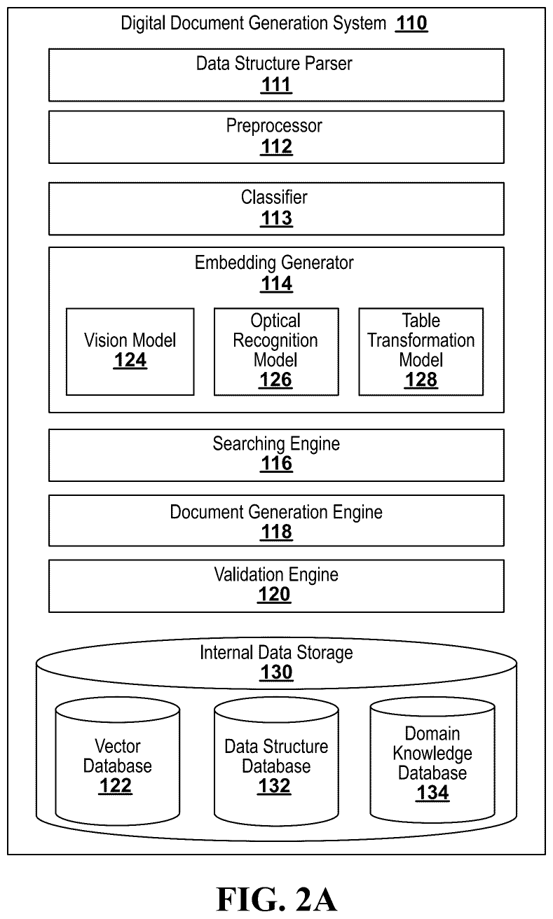

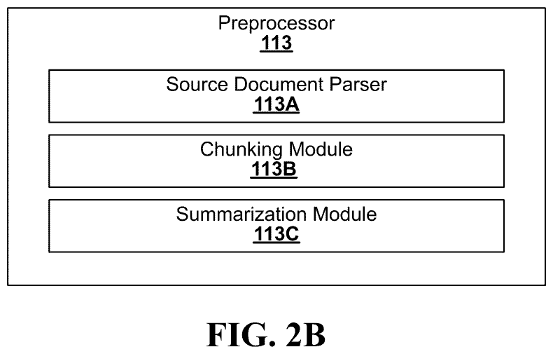

Reference is made to FIG. 2A which shows a block diagram of a digital document generation system 110, in accordance with an embodiment. The digital document generation system 110 can include more or fewer components, depending on the specific implementation of the digital document generation system 110.

The digital document generation system 110 can include a data structure parser 111, a preprocessor 112, a classifier 113, an embedding generator 114, a searching engine 116, a document generation engine 118, an internal data storage 130, and in at least some embodiments, a validation engine 120. The data structure parser 111, the preprocessor 112, the classifier 113, the embedding generator 114, the searching engine 116, the document generation engine 118, and the validation engine 120 may be implemented by a processing subsystem of the digital document generation system 110.

The data structure parser 111 can be configured to select or receive a data structure. The data structure can be a structured input that defines the document segments of a digital document. The data structure can be specific to the digital document being generated and can be a schema that defines how the digital document is to be organized and the purpose of the document segments of the data structure.

In at least some embodiments, the data structure is specific to a domain to which the digital document being generated relates. For example, different domains (sectors) (e.g., banking, mining, project finance) may be associated with different data structures.

The data structure can be received or stored in any structured input format that can be parsed to enable the digital document generation system 110 to understand the digital document to be generated, for example, as a table, an array, a tree structure, a graph, etc. The data structure can be received in any format that enables information about the document segments to be conveyed, including, but not limited to, XML, JSON, CSV, . xlsx, Python.

The data structure can be prepared by a user for a specific digital document being generated or, in some cases, can be derived from historical digital documents prepared by analysts/associates.

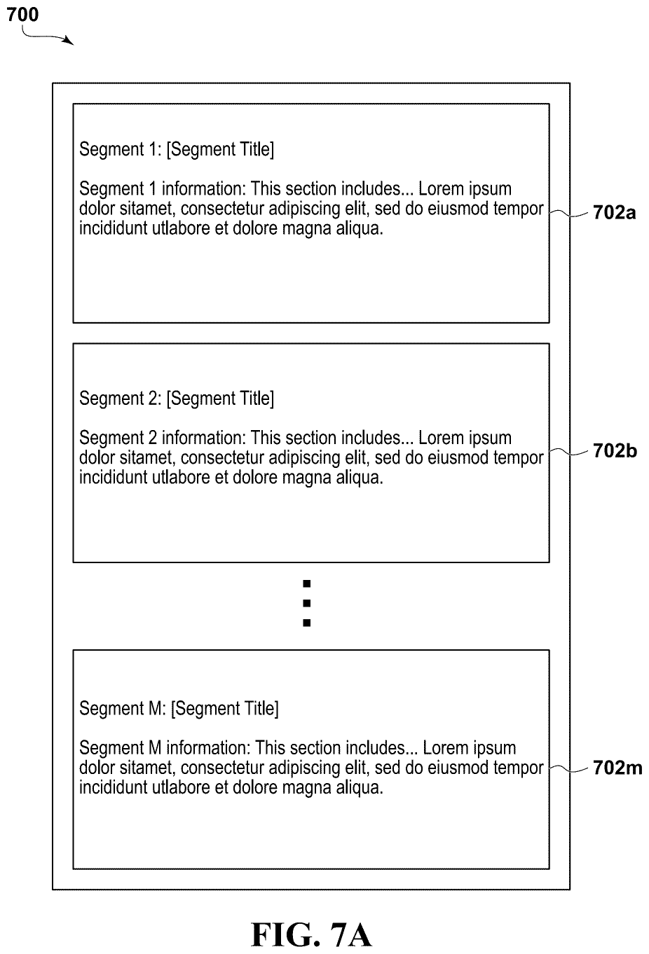

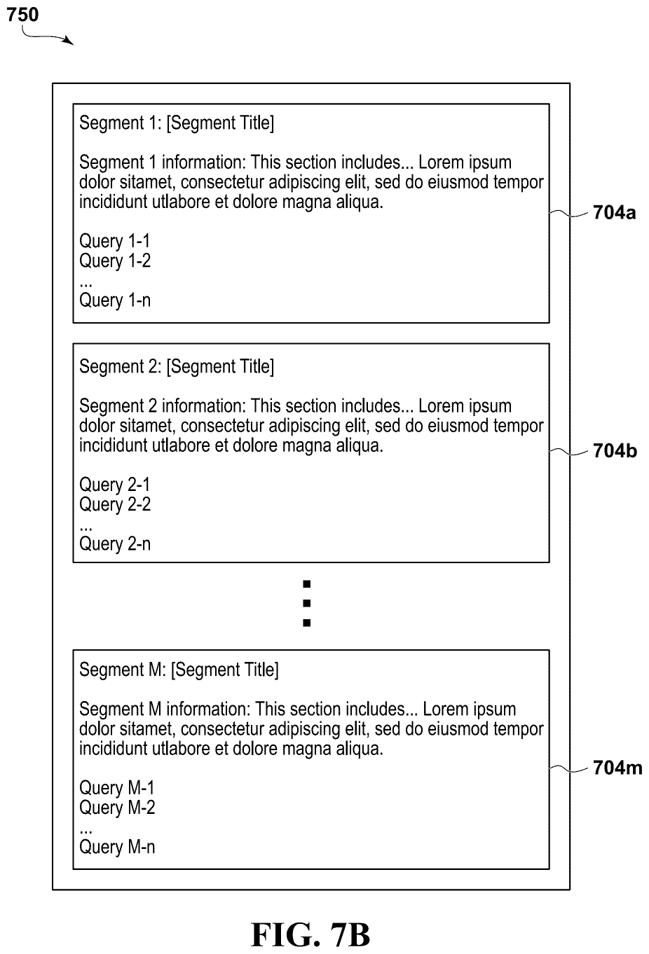

Referring to FIGS. 7A-7B, shown therein are data structures 700, 750 that may be received by the document generation system 110. As shown, the data structures 700, 750 include document segments 702a-702m, 704a-704m.

As shown, each segment 702, 704 includes information about the segment. For example, information about a segment can include a content of the segment (i.e., information to be included in the segment), a relationship between the segment and other segments, an order or location of the segment within the document or relative to other segments, and a format of the segment (e.g., number of paragraphs, sentence length, whether the segment includes bullet points or paragraphs).

The document segments can correspond to sections of a document (e.g., sections as delineated by headers, sub-headers, etc.), subsections of a document, paragraphs of a document, or any unit of a document.

In some embodiments, as shown in FIG. 7B, the document segments 704 include queries. The queries can include one or more questions that enable information relevant to generating textual content for the document segment 704 to be retrieved.

Referring again to FIG. 2A, the data structure parser 111 can receive or select a data structure. In embodiments where the data structure is selected, the data structure parser 111 can, upon receiving an indication of a type of digital document to be generated, retrieve the data structure corresponding to the type of digital document from the data structure database 132.

In embodiments where the data structure is received, the digital document generation system 110 can receive a data structure. In such embodiments, the data structure parser 111 can parse the received data structure so that the data structure can be understood by the digital document generation system 110.

The data structure parser 111 can parse the data structure and convert the data structure into a format that can be understood by the document generation engine 118. For example, the data structure parser 111 can extract the different document segments in the data structure so that each segment can be processed individually by the document generation engine (e.g., the textual content for each segment is generated separately). The data structure parser 111 can configure the document generation engine 118 so that the digital document generated includes the document segments defined in the data structure.

The preprocessor 112 is configured to preprocess source documents. As depicted in FIG. 2B, the preprocessor 112 includes a source document parser 112A, a chunk generator 112B, and a summarizer 112C. The source document parser 112A is configured to parse source documents of different types and formats. The source document parser 112A can also be configured to remove non-substantive content from source documents. The chunk generator 112B can be configured to divide source documents into a plurality of data chunks. The summarizer 112C is configured to generate a concise, context-rich summary for each parsed data chunk of a source document.

A data chunk, as used herein, refers to a discrete unit of content derived from a source document that can be independently embedded, indexed in the vector database 122, and retrieved by the searching engine 116. In some embodiments, the chunk generator 112B employs a structure-based chunking strategy in which the boundaries of each data chunk are determined based on structural elements of the source document, such as a paragraph, a section, a sub-section, a table, a figure and its associated caption, a page, a group of related sentences, or any other logically delineated portion of one or more source documents. Each data chunk can be associated with metadata including a source document identifier, a position within the source document from which the data chunk originates, and the class label associated with the source document.

In some embodiments, the source document parser 112A is configured to support ingestion of a plurality of different source document types. The source document parser 112A can include a plurality of parsing modules, each configured to process a different type of source document. For example, the source document parser 112A can include parsing modules for processing emails (including inline content and attachments), scanned images, screenshots, portable document format (PDF) files, and spreadsheet files (e.g., Excel files) having multiple tabs and diverse table layouts. The source document parser 112 can employ a modular parsing framework to be context-aware, such that different parsing modules are applied depending on the type and structure of the source document being processed.

The parsing modules can be configured to reconstruct machine-readable tables from source documents having unstructured or inconsistent formatting. For example, spreadsheet files received as source documents may include tables with irregular formatting, merged cells, inconsistent headers, or other structural anomalies. The source document parser 112A can normalize such tables to produce structured, machine-readable data chunks. For example, multi-row headers may be flattened with lineage to original cells and data arrays may be converted into lower dimensional hierarchical structures. In some embodiments, each individual table identified and separated by the parsing module is associated with a summary generated by the summarizer 112C describing the content and context of the table, enabling more accurate downstream retrieval and textual content generation.

In some embodiments, the source document parser 112A includes a scanned-page detection module configured to identify pages of source documents that include scanned content, as opposed to digitally rendered content. The scanned-page detection module can analyse characteristics of a page of a source document, such as a character density and a page structure, to determine whether the page includes scanned content. The density of detected text in a scanned page can additionally be recorded in the associated document/chunk metadata, which can be ingested by the classifier 113 in determining the relevance and quality of the content within the particular document/chunk for later retrieval.

The source document parser 112A may additionally coordinate with the vision model 124, optical recognition model 126, and table transformation model 128 by identifying regions of graphical data, scanned textual data, and structured tabular data in the source document/chunks for further deployment of the corresponding model for embedding generation.

The summarizer 112C of the preprocessor 112 can generate summaries that capture the main points and key metrics of a data chunk, and can annotate each summary with one or more contextual tags. The contextual tags can include, but are not limited to, a reporting period (e.g., a fiscal year, a quarter), an entity or subsidiary to which the data chunk relates, and a financial topic or subject matter (e.g., revenue, debt covenants, capital expenditure). The contextual tags can be determined by the preprocessor 112 based on the content of the data chunk, metadata associated with the source document(s) from which the data chunk originates, or a combination thereof. Each summary generated by the summarizer 112C can be associated with the original data chunk from which it was generated, maintaining traceability between the summary and the underlying source content.

The classifier 113 can maintain a classification model that is configured to classify documents. The classification model can classify source documents based on metadata associated with the source documents and/or the content of the source documents. For example, the classifier 113 can receive content information from preprocessor 112 to determine its content. The classifier 113 can employ NLP techniques to perform a semantic analysis of a source document to determine its content.

In some embodiments, the classification model is a rule-based model. In such embodiments, each class label may be associated with one or more rules, which may be predefined by a user. For example, rules associated with a class label can be associated with properties of documents typically associated with the class label. The rules can indicate properties of documents, for example the number of pages in a document, the author of the document, sections of the document, content included in the document, etc. When a source document is received, the document may be evaluated against the rules associated with each class label and the classifier 113 can assign a class to the source document based on the rules.

For example, rules for the class label “external agency report” can include: a document that has 10-15 pages, is authored by an agency, includes a credit rating/outlook analysis, includes an assessment of a company, includes a credit rating analysis, a rating driver, rating action rationale and/or a company outlook. In response to identifying that a given document includes one or more of these properties, the classification model can associate the document with the class label “external agency report”. The number of rules required to be satisfied to associate a document with a particular class label can vary, depending on the specific implementation of the classification model.

In other embodiments, the classification model is a machine-learning-enabled classifier (e.g., linear model, probabilistic model, tree-based model, neural network model, etc.). In such embodiments, the classification model can be trained on labeled source documents or can be trained using any other machine learning training technique, including unsupervised learning and reinforcement learning. For example, the classification model can learn, from labeled source documents, features of source documents and predict class labels for new source documents.

The classifier 113 can associate class labels to source documents. The class labels can vary, depending on the type of document being generated, the training data on which the classifier is trained, and the specific application of the digital document generation system 110.

For example, different organizations may employ different class labels or prioritize certain source documents when generating a digital document and accordingly, the training data can be specific to an organization.

Example class labels can include “corporate report”, “corporate news”, “internal equity research”, “external agency report”, “sustainability report”, “S&P capital data”, “term sheet”, “previous credit narrative”, or “credit agreement”.

In some embodiments, the digital document generation system 110 can maintain different sets of class labels and each set can be associated with a type of document. When an input indicating a type of document is received, the digital document generation system 110 can retrieve the set of class labels associated with that type of document. Alternatively, upon receiving the data structure, the digital document generation system 110 can determine the type of document being generated and retrieve the set of class labels associated with that type of document.

The class labels can indicate relevance to a particular document segment of a document being generated.

In some embodiments, the classifier 113 is configured to perform classification on a data chunk by data chunk basis.

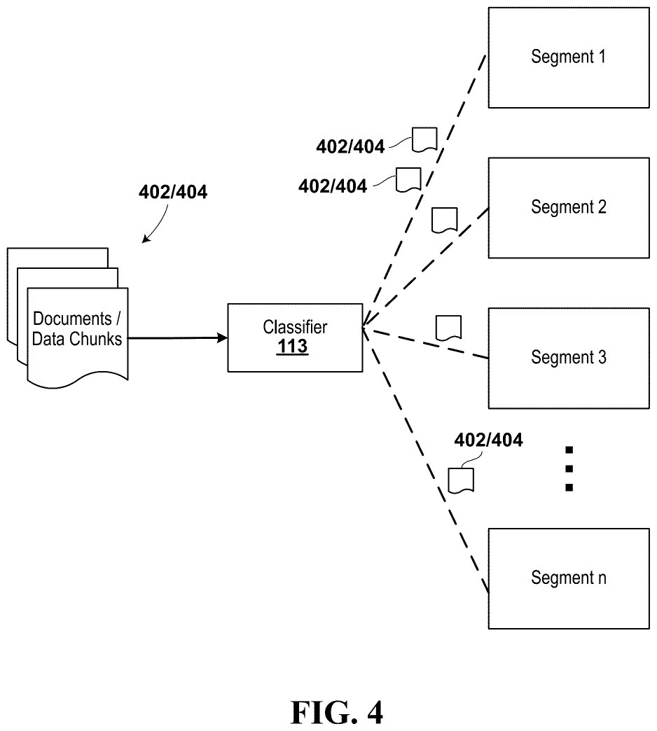

Referring to FIG. 4, as shown, the classifier 113 can process each source document 402 or data chunk 404 and associate, to each source document 402 or a data chunk 404, a class label that indicates relevance to a document segment (e.g., segment 1 to n). For example, the content of different document segments may be generated using information from various source documents 402 and data chunks 404. The class labels can indicate that a given document or data chunk is of a certain type, which may be relevant to generating the textual content of a particular desired document segment.

For example, to generate the textual content of each document segment, information from different source documents 402 or data chunks 404 may be used, and the textual content of each document segment may be generated with information from specific classes of documents. For example, the textual content of a given segment of a digital document is conventionally prepared using one or more documents labeled “corporate news”, therefore source documents 402 with “corporate news” as title or data chunks 404 under similar subheadings may be prioritized in the classification process.

For example, to generate the content of a “business model” document segment, information from source documents having class labels “corporate report”, “corporate news”, “agency report”, “equity research” and “previous credit narrative” may be relevant. Assigning a class label of “corporate report” to a given source document can be indicative that the source document is relevant to generating the content of the document segment “business model”.

The classification model can determine a class for a source document based on the number of pages in the document, the file name of the document, the headings in the document (e.g., parsed from the document, parsed from the table of contents of a document), the contents of a portion of the source document (e.g., a data chunk), or any combination of these.

In some embodiments, the classifier 113 can associate one or more class labels to each source document, indicating that the source document is relevant to one or more document segments. For example, a source document can include different sections that may be relevant to different segments of a source document. In such cases, the classifier 113 can associate different class labels to portions of a source document (e.g., data chunks).

In some embodiments, the classifier 113 is trained to associate a single class label to each source document. In such embodiments, the class label can correspond to the segment to which the source document is most relevant. For example, in some cases, a source document may be relevant to multiple segments of the source document. In such cases, the classifier 113 may identify the segment to which the source document is most relevant and associate the source document with the class label indicating relevance to the identified segment.

The embedding generator 114 is configured to generate embeddings of source documents that preserve the semantic meaning of the source documents, for example, vector embeddings of source documents.

The embedding generator 114 can be configured to convert multimodal source documents (e.g., text, images, tables) into a uniform representation so that the source documents can be stored in a common database and the embeddings corresponding to the different modes of information can be compared.

For example, the embedding generator 114 can include one or more vision models 124 configured to interpret images in source documents, one or more optical character recognition models 126 that are configured to convert images into text, and/or one or more table transformation models 128 configured to convert information presented in tables into text that is then semantically embedded.

The table transformation model 128 can be configured to convert a table into a natural language description based on rule-based templates, for example, certain tables in source documents may be standardized and the digital document generation system 110 may maintain templates of standardized tables (e.g., Column A shows X for year Y) and/or neural table-to-text generators (i.e., neural networks fine-tuned on table summarization tasks). The natural language description can then be embedded into a vector representation.

Alternatively, the table transformation model 128 can be configured to generate an embedding of a table by flattening the table into a sequence of tokens, encoding metadata relating to the table (e.g., column names, row names, data types), and encoding each cell, header, and position into a vector representation.

Summaries generated by the preprocessor 112 can be stored as part of metadata associated with the documents/data chunks. Alternatively, the summaries may be embedded as vectors alongside the original documents/data chunks to improve downstream search accuracy, efficiency, and context-awareness. Such a treatment of the generated summaries overcomes the limitations of embedding long, noisy documents, which can dilute the semantic meaning in a vector space.

The searching engine 116 is configured to search the vector database 122 for search results that are relevant to a document segment. For example, the searching engine 116 can submit a query to the vector database to obtain search results responsive to the search query. The searching engine 116 can receive a set of queries for information relevant to document segments and generate a search query based on the set of queries received. In some embodiments, each document or underlying data chunk's associated metadata may be queried by the searching engine 116 during the search process to efficiently filter for relevant and high-quality data.

In some embodiments, the searching engine 116 implements a hybrid retrieval architecture that performs parallel lexical and semantic retrieval. The searching engine 116 combines the results of a keyword-based lexical search and a meanings-based semantic search to generate a combined set of candidate search results.

In some embodiments, the searching engine 116 includes a section-tuned query augmentation module configured to augment queries prior to submission to the vector database 122. The input queries could be pre-configured and associated with each document segment, such as the queries in data structure 750, or other system or user generated queries to facilitate document generation. The section-tuned query augmentation module can augment a query based on the template context of the document segment for which textual content is being generated and domain-specific terms retrieved from the domain knowledge database 134. For example, for a query associated with a “financial ratios” document segment, the query augmentation module can append domain terms such as “EBITDA”, “leverage ratio”, or “debt service coverage” to the query, improving the precision and recall of the search results.

In some embodiments, the searching engine 116 applies a context-driven re-ranking layer that applies domain-specific rules to filter and prioritize candidate search results. The domain-specific rules can include rules for matching a reporting period, a statement type, an entity or subsidiary, and a consolidation scope associated with each candidate search result to the requirements of the document segment for which textual content is being generated. For example, when generating textual content for a document segment relating to a specific fiscal year, the context-driven re-ranking layer can prioritize candidate search results whose associated contextual tags or metadata indicate relevance to that fiscal year, and deprioritise or filter out candidate search results that relate to a different reporting period.

In some embodiments, the searching engine 116 includes a specialized agent module configured to scan all parsed content available in the vector database 122. The agent module references the requirements of the document segment for which content is being generated, and selects the most relevant and authoritative documents/data chunks from among the candidate search results. The agent module can evaluate each candidate search result against the requirements of the document segment, including the content, scope, and level of detail specified by the data structure for the document segment. The agent module can generate a selection result indicating which candidate search results are selected for inclusion in the input instructions for the textual generation model.

In some embodiments, the searching engine 116 generates traceability information indicating why a particular data chunk was selected or rejected by the re-ranking module and/or the agent module. The traceability information can include the domain-specific rules applied by the re-ranking layer and the selection criteria applied by the agent module. The traceability information can be stored in association with the search results and can be made available to a user for audit and review purposes.

In some embodiments, the searching engine 116 is configured to search external databases, for example public database 170 for information that is not contained in the source documents and/or to validate information in the source documents. For example, the searching engine 116 can search the web or interface with APIs for automated data ingestion.

In some embodiments, the digital document generation system 110 includes a document generation engine 118 configured to implement a document generation model that generates digital documents.

In other embodiments, the document generation model is implemented by an external system and the digital document generation system 110 communicates with the external system to transmit input instructions to the document generation model and receive model outputs from the document generation model via a data network, such as network 150.

The language generation model may include one or more language models or large language models (LLM), that are configured to generate outputs in response to instructions provided to the language generation model.

The document generation engine 118 can be configured to receive outputs from a language generation model and generate a digital document based on the outputs. For example, the document generation engine 118 can assemble the outputs into a cohesive document, according to a predefined data structure for the digital document.

In some embodiments, document generation engine 118 includes a financial calculation module configured to perform calculations on raw numerical data extracted by the data structure parser 111, labelled by the classifier 113 as relevant data, and/or summarized by the preprocessor 112 from the source documents and chunks. The financial calculation module can be configured to compute one or more derived financial metrics from the raw financial data. The derived financial metrics can include, but are not limited to, custom financial ratio calculations (e.g., debt-to-equity ratio, current ratio, interest coverage ratio, return on equity), variance analyses (e.g., year-over-year comparisons, period-over-period comparisons of financial line items), and other domain-specific metrics relevant to the digital document being generated (e.g., credit-related metrics such as debt service coverage ratio, leverage ratio, and liquidity ratio).

The financial calculation module can output the computed metrics in a structured format. The computed metrics can be stored in the vector database 122 in association with the embeddings of the source documents from which the raw financial data was extracted, and/or provided directly for inclusion in the input instructions for the language generation model. By computing derived financial metrics from raw financial data extracted from the source documents, the financial calculation module can enable the language generation model to generate textual content that incorporates accurate, computed financial information without requiring the language generation model to perform calculations, reducing the risk of computational errors in the digital document generated.

In some embodiments, the financial calculation module maintains a library of predefined calculation templates, each associated with a type of digital document and/or a domain. For example, for credit narrative reports, the calculation templates can include templates for leverage ratios, liquidity ratios, profitability ratios, and cash flow metrics. The financial calculation module can retrieve the calculation templates corresponding to the type of digital document being generated and apply the retrieved templates to the raw financial data to compute the derived financial metrics. By maintaining predefined calculation templates, the financial calculation module can ensure consistency and auditability in metric computations across different digital documents and different sets of source documents.

In some embodiments, the document generation engine 118 is configured to automatically generate structured tables from parsed data chunks and/or computed metrics generated by a financial calculation module, for direct inclusion in the digital document as document segments.

The validation engine 120 can be configured to evaluate digital documents generated. For example, the validation engine 120 can determine whether an output generated by the language generation model is supported by information in the source documents. In some cases, the language generation model may generate outputs that may contain content not supported by the source documents (e.g., hallucinated content). The validation engine 120 can be configured to identify this content.

The validation engine 120 can determine a validation result based on a measure of roundness (i.e., faithfulness) that characterizes the extent to which statements in the digital document are supported by the source documents used for generating the digital document or can be inferred from the source documents. Relevant content from the source documents that is ignored or only partially addressed will be flagged by the validation engine 120 for segment regeneration or manual intervention.

For example, the validation engine 120 can evaluate each segment of a digital document using a dedicated LLM to determine whether the natural language content of the document segment is supported by the source documents. A roundness score may be calculated and compared against a predetermined threshold to ensure sufficient faithfulness to the source documents.

In some embodiments, the validation engine 120 evaluates sub-segments (e.g., statements) of the digital document, determines a sub-segment validation result for each sub-segment and generates a segment validation result based on the sub-segment validation results of the sub-segments evaluated.

In some embodiments, the document generation engine 118 (via its language generation model) generates a digital document that includes citations for the different segments of the digital document or for the different statements contained in the digital document. For example, the outputs generated by the language generation model can include citations. In such cases, the validation engine 120 can validate the different segments/sub-segments in the digital document by parsing the source documents cited and identifying whether the information contained in the digital document is supported by (e.g., contained in, can be inferred from) the source documents cited, or by performing a semantic comparison of the segments/sub-segments and the cited source documents.

Alternatively, or in addition thereto, the validation engine 120 can validate segments or sub-segments of a digital document by comparing the textual content of the segment/sub-segment with the search results obtained by the searching engine 116.

Alternatively, or in addition thereto, the validation engine 120 includes one or more validation LLM(s), different from the LLM of the language generation model, and the validation LLMs are configured to validate the digital document generated. Validating the digital document using one or more validation LLM(s) can involve generating a validation digital document and comparing the validation digital document with the digital document generated, generating validation portions and comparing the digital document with the validation portions, and/or providing to the validation LLM(s) the digital document and instructing the validation LLM(s) to assess the content of the digital document with reference to the source documents. Generated textual content may additionally be compared against internal policy documents or business rules observed by the user entity.

The internal data storage 130 can store various types of data used by the digital document generation system 110 for generating digital documents. For example, the internal data storage 130 can store data that is frequently accessed by the digital document generation system 110. For example, the internal data storage 130 can include a data structure database 132 that stores data structures that define document segments of digital documents to be generated. The data structure database 132 can store data structures in association with types of digital documents.

In some embodiments, the internal data storage 130 may not include a data structure database 132 and the data structure database 132 may instead be implemented by an external system, for example, the data structure database 132 may reside on the external data storage 154.

In some embodiments, the internal data storage 130 stores source documents. For example, the internal data storage 130 can temporarily store source documents used for generating a digital document while the digital document is being generated and/or validated.

In some embodiments, the internal data storage 130 includes a vector database 122 that stores embeddings of source documents generated by the embedding generator 114.

In other embodiments, the vector database 122 is implemented by an external system and the digital document generation system 110 communicates with the vector database via a network, such as network 150. For example, the vector database 122 can be a cloud-based database.

The domain knowledge database 134 can store information that may be used for improving the digital document generation system's 110 semantic understanding of queries and of source documents, for example, glossaries (e.g., defining synonyms) and disambiguation rules (e.g., rules for resolving similar terms). The domain knowledge database 134 can store this information in association with the domain to which it relates. For example, the domain knowledge database 134 can maintain different sets of domain-specific knowledge, which can be retrieved based on the domain to which the digital document being generated relates (e.g., banking and financial services, insurance, investment, regulatory compliance, consumer credit, environment, etc.). The digital document generation system 110 can identify a domain for a digital document based on the type of document generated and/or the source documents received.

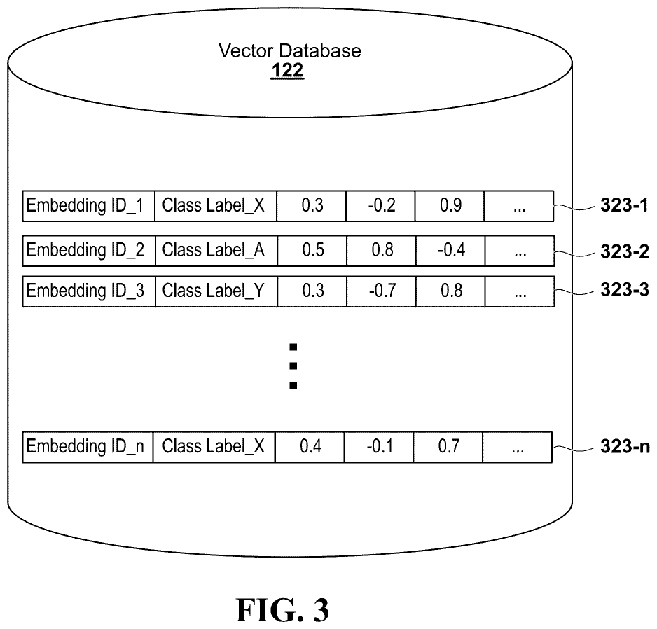

Referring to FIG. 3, shown therein is an example schema 300 of the vector database 122. As shown, the vector database 122 can store a plurality of vector embeddings 323-1 to 323-n, which can correspond to source documents or data chunks of source documents. As shown, each embedding 323 can include an embedding ID, which can be associated with a source document, a class label associated by classifier 113, a vector representation of the source document/the portion of the source document (such as a data chunk 404), and in some embodiments, a summary generated by the preprocessor 112. The summary can include contextual tags, such as a reporting period, an entity or subsidiary, and a financial topic, enabling the searching engine 116 to filter and rank embeddings based on contextual relevance in addition to semantic similarity. The summary may be stored in its plaintext or vectorized forms.

The embedding ID can enable the digital document generation system 110 to retrieve the source document associated with the embedding 323 and/or information about the source document. For example, as explained, in some embodiments, the digital document generation system 110 implements a validation engine 120 configured to validate the accuracy of a digital document generated by the digital document generation system 110. As described, the language generation model can include, in its outputs, citations identifying the one or more source documents used for generating the output. The digital document generation system 110 can identify those documents based on the embedding ID. For example, the search results obtained by the searching engine 116 can correspond to the embeddings 323, which can include information about the source documents via the embedding ID.

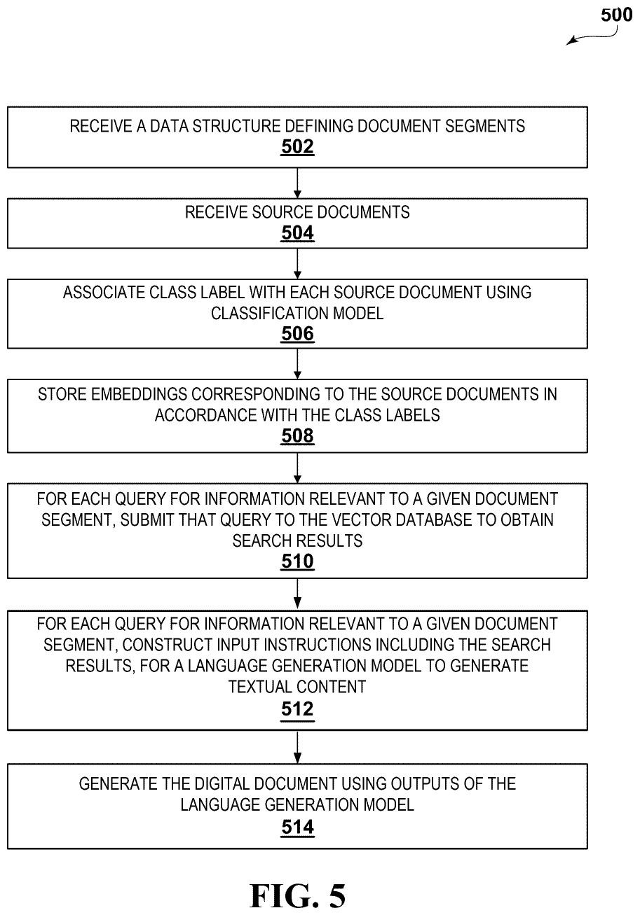

Reference is made to FIG. 5, which shows a flowchart of an example method 500 of generating a digital document that may be performed by the digital document generation system 110.

At 502, the digital document generation system 110 receives a data structure that defines a plurality of document segments. As explained with reference to FIG. 2, the data structure can be specific to the digital document being generated and can be a schema that defines how the digital document is to be organized and the purpose of the document segments of the data structure.

In some embodiments, the digital document generation system 110 receives an input indicating a type of document to be generated, and based on the type of document to be generated, the digital document generation system 110 can request the data structure corresponding to the type of document. For example, a user may interact with a user device 180 to transmit to the digital document generation system 110 a request to generate a particular type of report (e.g., credit narrative, term sheet, ESG report). In response to receiving the input, the digital document generation system 110 can request and receive the data structure corresponding to the type of document requested.

At 504, the digital document generation system 110 receives source documents. The digital document generation system 110 can receive source documents via a data communication subsystem of the digital document generation system 110.

For example, a set of source documents relevant to generating a digital document can be stored in a portion of a data storage (e.g., source document data storage 160), and the digital document generation system 110 can retrieve the set of source documents.

In some embodiments, source documents relevant to a digital document being generated can be selected by a user, and the digital document generation system 110 can receive the source documents selected by the user. For example, in some embodiments, the user can collect the set of source documents relevant to generating the digital document.

In other embodiments, the digital document generation system 110 is in communication with a document management system and the digital document generation system 110 retrieves the source documents associated with the digital document to be generated from the document management system.

At 506, the digital document generation system 110 associates at least one class label with each source document received at 504 using the classification model. The class labels can indicate a relevance to a particular document segment. As explained, the digital document generation system 110 can maintain a classification model that is configured to classify particular documents for relevance to particular document segments.

As explained, in some cases, the digital document generation system 110 associates a class label to portions of the source documents.

At 508, the digital document generation system 110 stores, in a vector database, embeddings corresponding to the source documents. The embeddings of the source documents can be stored in association with the class labels. The vector database can be as described with reference to FIGS. 2-3.

As explained with reference to FIG. 2, the vector database can be a local database maintained by the digital document generation system 110 or can be an external database in communication with the digital document generation system 110.

As explained, in some embodiments, the digital document generation system 110 includes an embedding generator 114 that is configured to generate vector embeddings of the source documents.

In other embodiments, the digital document generation system 110 transmits to an external embeddings system the source documents received, and the external embeddings system generates embeddings of the source documents.

In some embodiments, each embedding corresponds to a source document, that is, the vector database stores each source document as a single embedding. In other embodiments, multiple embeddings can be generated for each source document. In such cases, the embedding generator 114 can embed, in the embedding associated with each portion of the source document, information about the source document from which the portion originates.

In some embodiments, prior to storing the embeddings, the preprocessor 112 removes less relevant content from the source documents and reduces the size of the source documents. By preprocessing the source documents, the digital document generation system 110 can reduce the size of the source documents, which can reduce the size of the embeddings of the source documents, which can in turn reduce memory requirements associated with the vector database for storing the embeddings associated with the source documents.

The content or corresponding data chunks to be removed can be data that is recognized by the classifier 113 as non-substantive content (e.g., content that does not contribute to the substance of the source document), for example, standard disclaimers, table of contents. By removing such content, the language generation model can generate better outputs, since such content can be deemphasized.

The digital document generation system 110 can employ natural language processing (NLP) techniques to identify content to be removed. For example, the digital document generation system 110 can implement an NLP model that is configured to parse source documents and compare source documents and example non-substantive content. The example non-substantive content can be template content stored in a data storage of the digital document generation system 110 or an external data storage in communication with the digital document generation system 110.

The NLP model can compute a measure of similarity between portions of the source documents and the example non-substantive content, and when the measure of similarity exceeds a predetermined threshold, the NLP model can identify that a given portion of a source document includes content that may be removed and remove the content. In some embodiments, the NLP model ingests the generated summaries by the preprocessor 112 in its assessment of the relevance of an associated document/data chunk.

For example, the NLP model can identify that a portion of a source document is likely to be a disclaimer based on its similarity to example disclaimers and discard the identified portion of the source document.

In some embodiments, the digital document generation system 110 generates a brief description of each source document/data chunk and stores the embedding in association with the brief description. For example, the digital document generation system 110 can parse the source document and generate a summary of the source document.

At 510, for each query for information relevant to a given document segment, the digital document generation system 110 submits that query to the vector database to obtain search results that are responsive to that query. The search results can include embeddings of one or more source documents that are responsive or relevant to the query or embeddings of portions of source documents, depending on the manner in which the source documents are embedded.

The search results can be from the embeddings that are associated with class labels that indicate relevance to the given document segment. The search results can correspond to source documents or portions of source documents, depending on the manner in which the source documents are embedded and/or the specific implementation of the digital document generation system 110.

By searching those embeddings that are associated with specific class labels, the digital document generation system 110 can prioritize a subset of embeddings, more efficiently locate search results, and reduce searching time and processing resources associated with the search. In addition, by applying the re-ranking module and the context-driven re-ranking layer of the searching engine 116 to the candidate search results, the digital document generation system 110 can further refine the search results to identify those that are most relevant to the specific requirements of the document segment, including matching the reporting period, entity, statement type, and consolidation scope associated with the document segment.

In embodiments where the embeddings are stored in association with summaries of the source documents/data chunks, the search results can be obtained in response to a search of the summaries to enhance the relevance of the search results. For example, the searching engine 116 can compare the query against the contextual tags and key metrics in the summaries to identify documents/data chunks that are relevant to a specific reporting period, entity, or financial topic, even when multiple documents/data chunks share similar keywords. By leveraging the summaries and contextual tags generated by the preprocessor 112, the searching engine 116 can reduce the incidence of irrelevant search results and improve the quality of the search results provided to the language generation model.

In some embodiments, the digital document generation system 110 receives a set of queries for information. For example, the set of queries for information can be provided to the digital document generation system 110 in the form of a questionnaire.

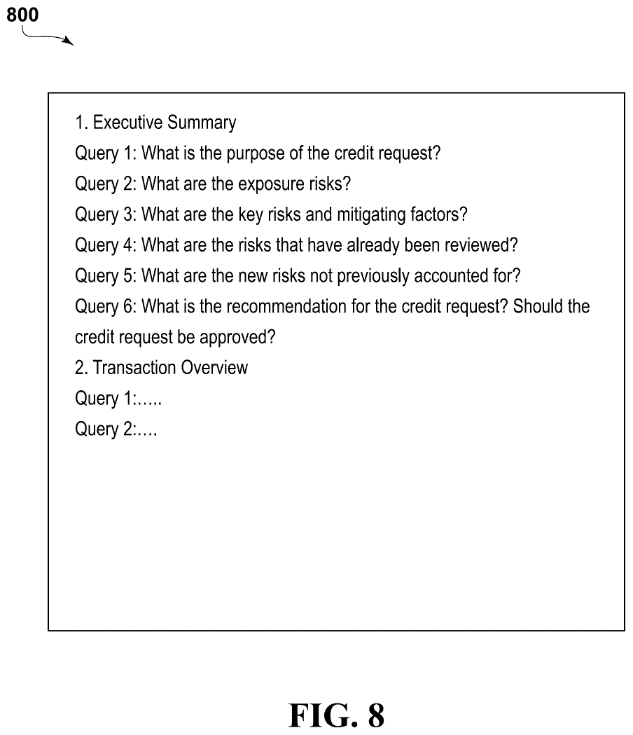

FIG. 8 shows an example set of queries that may be received by the digital document generation system 110. As shown, the queries can be associated with sections of the digital document, which may correspond to document segments or may include document segments.

The query can include one or more questions that enable information relevant to generating textual content for a given document segment to be retrieved. In some embodiments, the query includes one or more keywords to be searched. For example, the query can indicate that the search results should include one or more given keywords.

An example query for a corporate report can be “What is the composition of the company's board of directors?”. In this example, the search results can include embeddings of one or more source documents or portions of source documents that include information about the members of the board of directors, the number of directors, whether the members of the board of directors are independent, etc. Since information from multiple source documents may be relevant to a query, the search results can include embeddings corresponding to multiple source documents.

For example, the query “What is the composition of the company's board of directors?” may be relevant to the document segment “Board of Directors” and information from source documents having class labels “corporate report”, “corporate news”, “external agency report” and “equity research” may be relevant to the document segment and the query.

In some embodiments, the digital document generation system 110 retrieves or receives historical digital documents, which can include digital documents prepared by users, for example, analysts. The digital document generation system 110 can submit the historical digital documents or portions of the historical digital documents (e.g., portions corresponding to the document segments) and obtain search results based on the embeddings. For example, the search results obtained can include embeddings that are semantically similar to the embeddings of the historical digital documents.

In some embodiments, the query can include a class label priority. A class label priority can indicate that information from source documents having one or more specific class labels should be prioritized over source documents associated with other class labels when locating search results. For example, a class label priority can indicate that source documents having class labels “external agency report” and “equity research” should be prioritized when generating textual content for the document segment “Board of Directors”. The class label priority can indicate one or more priority tiers. For example, the class label priority can indicate that source documents having class label “external agency report” are associated with the highest level of priority and source documents having class label “equity research” are associated with the second highest level of priority. The priority tier can indicate the order in which documents are prioritized during the search and/or the information to prioritize when generating textual content.

In other embodiments, the digital document generation system 110 can maintain class label priorities associated with each type of document segment and each type of document. The class label priorities can be predetermined, for example, can be determined by a user of the digital document generation system 110, and can be associated with a domain to which the digital document relates. For example, in some embodiments, each domain is associated with a set of class label priorities, such that different class labels are prioritized depending on the domain.

The vector database can return search results from documents having class label “external agency report” and “equity research” and, if the source documents associated with the labels “external agency report” and “equity research” do not include information responsive to the query, embeddings associated with the class labels “corporate report”, “corporate news” can be searched.

Alternatively, the class label priority can be included in input instructions for the language generation model, as will be explained with reference to step 512.

The query can enable a combination of a keyword and semantic search to be performed so that the search results obtained can include search results that may not include specific keywords included in the query but that are semantically relevant to the query. For example, to respond to the query “What is the composition of the company's board of directors?”, the keyword “director” and semantically related terms such as “CEO” may be used to search the vector database.

The queries for information can be specific to the digital document being generated. For example, different document types can be associated with different queries and/or different document segments can be associated with different queries.

In some embodiments, the data structure received at 502 includes the queries for information, as explained with reference to FIG. 7B.

In other embodiments, the digital document generation system 110 can retrieve a set of queries for information based on the digital document being generated.

In some embodiments, the digital document generation system 110 submits a query to an external system, for example, the digital document generation system 110 may search publicly available sources (e.g., public database 170) to obtain supplementary search results including information that may not be present in the source documents or that can be used in combination with the source documents. For example, the digital document generation system 110 can submit a query to an external database when the vector database does not include information responsive to the query. Alternatively, the digital document generation system 110 can submit each query to the external database. As another example, the digital document generation system 110 can submit a subset of queries to the external database, for example, queries associated with publicly available information.

In some embodiments, the digital document generation system 110 employs domain-specific knowledge for locating search results responsive to the query. The domain-specific knowledge can be retrieved from a domain knowledge database, such as domain knowledge database 134. The domain-specific knowledge can enable the query to be more accurately interpreted, improve semantic understanding of the query and enable search results that include synonyms of keywords to be located.

At 512, for each query for information relevant to the given document segment, the digital document generation system 110 constructs input instructions for a language generation model to generate textual language content for the given document segment. The input instructions include the search results obtained at 510 and in some cases, supplementary search results. As explained, the digital document generation system 110 can employ RAG to generate textual content for the different document segments. The input instructions can include input instructions given to an LLM to elicit a response and can include natural language text.

In some embodiments, the input instructions include domain-specific knowledge, which can be retrieved from a domain knowledge database, such as domain knowledge database 134. The domain-specific knowledge can enable the language generation model to generate textual content that is consistent with vocabulary and semantics typically used in documents associated with the domain of the digital document.

The content textual generated can be natural language text and can include citations identifying the one or more source documents and/or the one or more portions of the source documents used for generating the textual content (i.e., the source documents associated with the search results).

In some embodiments, the input instructions include the query and/or instructions to respond to the query, so that the textual content generated can be responsive to the query.

In some embodiments, the input instructions include a format for the output of the language generation model. The format for the output can define the desired output format of the output of the language generation model (e.g., a number of sentences, a length of the sentences, whether the textual content is to be presented using bullet points or paragraphs, a length of the paragraph) and form a guide for the language generation model.

In some embodiments, the input instructions include a tone, a target audience and/or a style for the output of the language generation model.

In some embodiments, the digital document generation system 110 retrieves or receives historical digital documents, which can include digital documents prepared by users, for example, analysts. The digital document generation system 110 can determine a historical structure for the output based on the historical digital documents and the input instructions can include the historical structure. The historical structure can enable the language generation model to generate textual content that is consistent with historical digital documents (e.g., style, tone, format). For example, the historical structure can supplement the general tone, style, and/or format included in the input instructions.

In some embodiments, the digital document generation system 110 receives or retrieves the historical structure, which may be generated by an external system.

In some embodiments, the input instructions include example outputs. Example outputs can be retrieved from a data storage maintained by the digital document generation system 110 or from an external data storage and can correspond to historical document segments or statements in historical documents (e.g., documents prepared by analysts/associates).

In some embodiments, the input instructions include a class label priority. As explained with reference to step 510, information from certain source documents may be prioritized when generating textual content for a given document segment. The input instructions can provide instructions to the language generation model to prioritize content from search results associated with one or more class labels when generating the textual content.

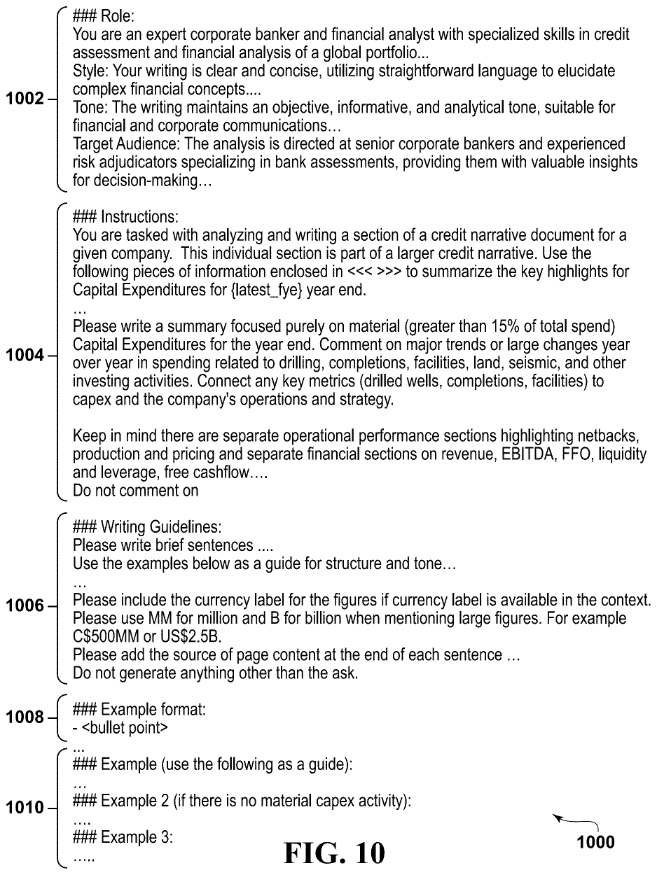

Reference is made to FIG. 10, which shows example input instructions 1000 that can be constructed by the digital document generation system 110 for a given document segment and provided to the language generation model.

As shown, the input instructions 1000 can include a role portion 1002. The role portion can include a description of the role of the language generation model, and a style, tone, and target audience of the output generated by the language generation model.

The input instructions 1000 can include a detail instructions portion 1004. The instructions portion 1004 can define the task of the language generation model and provide guidelines (e.g., constraints) for the language generation model. The instructions portion can include the search results obtained at 510 or a reference to the search results and any other substantive information relevant to generating an output.

The input instructions 1000 can include a writing guidelines portion 1006, which can define writing conventions for the language generation model and a structure for the output generated.

The input instructions 1000 can include an example format portion 1008, which can define the format of the output. In the example shown, the format includes bullet points.

The input instructions 1000 can include an examples portion 1010. The examples portion 1010 can include pre-generated examples and/or historical documents or portions thereof.

The input instructions 1000 can include fewer or more portions and can include more or less detail, depending on the document segment for which textual content is generated and on the specific implementation of the digital document generation system 110.

At 514, the digital document generation system 110 generates the digital document based on the outputs of the language generation model. The digital document generated is structured to include the document segments defined by the data structure received at 502. The digital document generation system 110 can generate the digital document by aggregating the outputs from the language generation model.

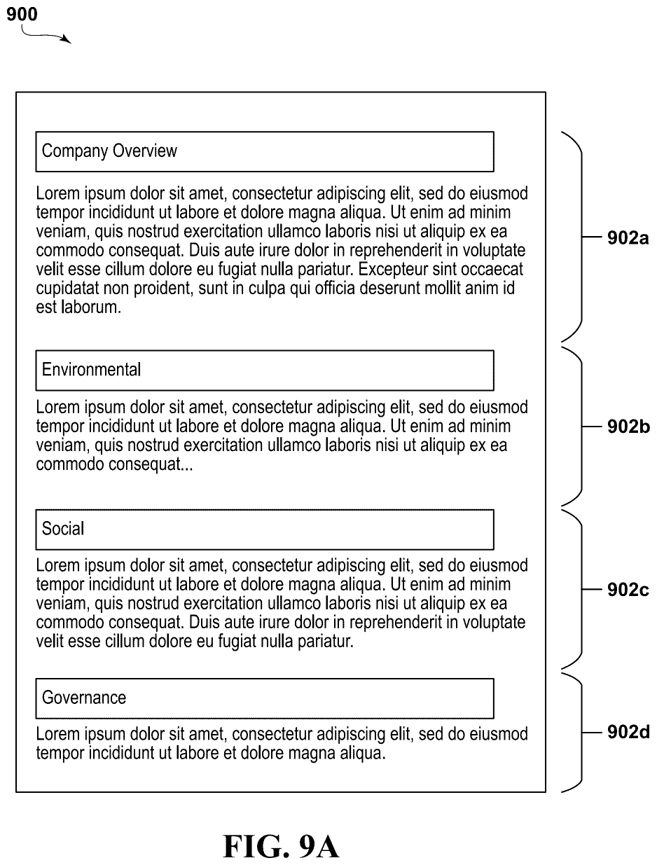

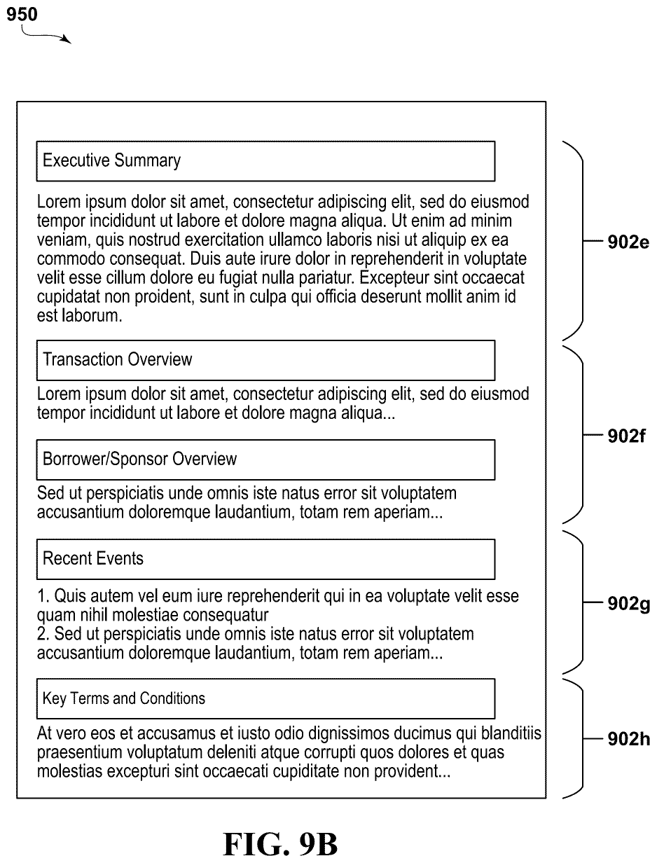

FIGS. 9A-9B show example digital documents 900, 950 that can be generated. As shown, the digital documents include segments 902a-902h, which can vary depending on the type of document generated. The segments 902 can correspond to the segments defined in the data structure received at 502.

In some embodiments, the digital document generated is validated for accuracy. For example, the digital document generation system 110 can implement a validation engine 120 that is configured to validate the digital document. Validating a digital document can involve verifying whether the textual content of the digital document is supported by the information in the source documents from which the content of the digital document is generated.

In some embodiments, the digital document generation system 110 can receive a feedback input provided in response to the digital document generated. For example, a user can provide a feedback input. The feedback input can include a recommendation for improving the digital document or a portion of the digital document or a question relating to the digital document or a section of the digital document.

In some embodiments, the feedback input can be provided via a chatbot that may be implemented by the digital document generation system 110 or, alternatively, be in communication with the digital document generation system 110. The chatbot can be an application that enables a user to converse with the digital document generation system 110.

The digital document generation system 110 can generate an updated digital document based on the feedback input. For example, the digital document generation system 110 can identify the one or more document sections to which the feedback input relates and can generate an updated query to the vector database based on the feedback input. The digital document generation system 110 can submit the updated query to the vector database to obtain updated search results, construct updated input instructions, receive updated outputs from the language generation model, and generate an updated digital document based on the updated outputs.

In some embodiments, the digital document generation system 110 can search external publicly available databases (e.g., the digital document generation system 110 can search the web) to supplement the updated search results, or to supplement the search results. In the latter case, the digital document generation system 110 may not generate an updated query to the database and may instead query the publicly available databases and construct updated input instructions based on search results from the publicly available databases.

In some embodiments, the digital document generation system 110 can validate the digital document generated. Validating a digital document can involve analyzing the textual contents of the digital document to identify whether the information in the digital document is supported by source documents.

In some cases, the language generation model may generate outputs that include unsupported information (e.g., hallucinations). The digital document generation system 110 can validate the textual contents of the digital document to identify unsupported information and present information about the unsupported information to a user (e.g., a reviewer reviewing the digital document generated).

In some embodiments, the outputs generated by the language generation model include citations identifying one or more sources for the outputs (e.g., an identification of one or more source documents, one or more data chunks of a source document) and class label(s) associated with the one or more sources. In such embodiments, to validate the digital document generated, the digital document generation system 110 can retrieve the source documents based on the class labels, search the sources, and determine whether the information in the digital document is supported by the sources.

The digital document generation system 110 can generate a validation result, indicating whether the digital document or a portion of the digital document being evaluated is supported, and in some cases, a measure of faithfulness characterizing the extent to which the digital document is supported by the source documents.

In some embodiments, to validate the digital document, the digital document generation system 110 segments the digital document into sub-segments and evaluates each sub-segment separately. A sub-segment can, for example, correspond to a statement in the digital document. In such embodiments, the outputs generated by the language generation model can include citations for each sub-segment. The digital document generation system 110 can generate a segment validation result based on the sub-segment validation results of each of the sub-segments.

The validation result(s) can be included in the digital document or can be provided separately, for example, displayed on a GUI of the digital document generation system 110. A low measure of faithfulness or an indication that the digital document or a portion thereof is unsupported can indicate that a digital document may require manual review.

The digital document generation system 110 can generate an explanation of the validation result. For example, in a document that includes the statement “Acme's Board of Directors comprises eight members, including John Smith, as Executive Chair and Jane Doe as Lead Director. The board includes five independent directors: Richard Roe, Sue Donym, Eric Widget, Indigo Violet and Barry Tone, which constitutes 62.5% of the board as independent members”, the document generation system 110 can generate the explanation: “Explanation of unfaithful: The context does not provide the percentage of independent members. Hilary Ouse serves as CEO and Director, Hans Down is also a Director. The Executive Chair, John Smith, is not independent, which indicates that the Chair is not independent.”

In some embodiments, when the digital document generation system 110 determines that the digital document includes information that is unsupported, the digital document generation system 110 generates an alert to notify a user that at least portions of the digital document may contain information that is unsupported. The digital document generation system 110 can identify unsupported statements. For example, the digital document generation system 110 can cause the digital document to be displayed and cause unsupported statements to be displayed in a contrasting color or accompanied by a warning message.

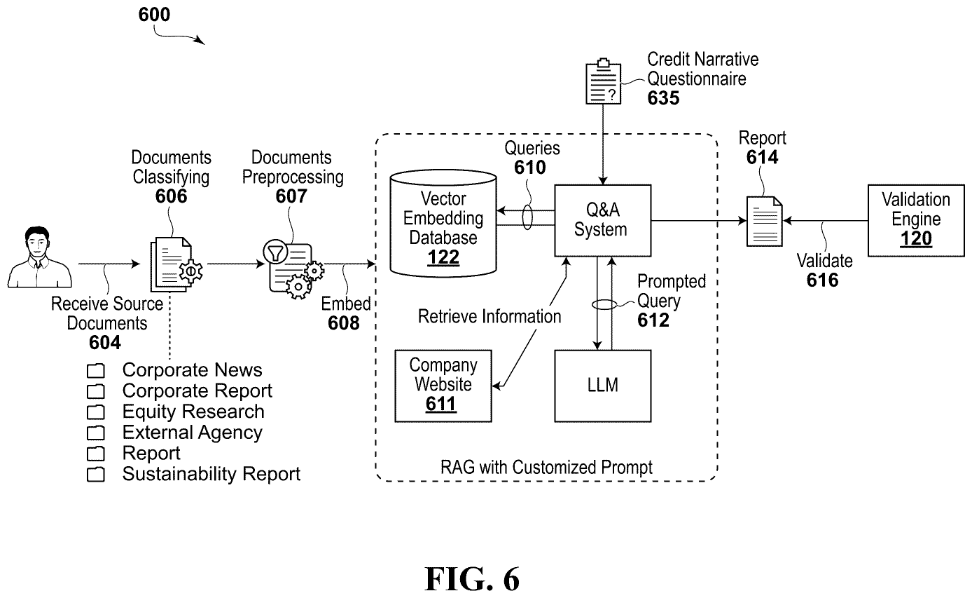

Reference is briefly made to FIG. 6, which shows a pictorial representation of an example method 600 of generating a credit narrative report that may be implemented by the digital document generation system 110. Method 600 can be substantially similar to method 500.

At 604, similar to 504, the digital document generation system 110 receives source documents. Prior to receiving source documents, the digital document generation system 110 can receive a data structure that defines document segments of the digital document to be generated, similar to step 502 of method 500.

At 606, the digital document generation system 110 associates a class label with each source document received at 604 using the classification model.

At 607, the digital document generation system 110 preprocesses the source documents to remove content from the source documents and reduce the size of the source documents, as described with reference to method 500.

At 608, the digital document generation system 110 generates embeddings of the preprocessed source documents and stores the embeddings in the vector embedding database 122.

At 610, similar to 510, for each query for information relevant to a given document segment, the digital document generation system 110 submits that query to the vector database to obtain search results that are responsive to that query.

In the example of method 600, the digital document generation system 110 receives a credit narrative questionnaire 635 that includes the queries.

At 611, for at least some queries for information relevant to a given document segment, the digital document generation system 110 submits a query to a publicly available database. For example, the digital document generation system 110 retrieves information from the web (e.g., the website of the company to which the digital document relates).

As explained with reference to method 500, in some embodiments, the digital document generation system 110 searches the web when information responsive to the query is not available in the vector embedding database 122. In other embodiments, the digital document generation system 110 searches the web to supplement the search results from the vector embedding database 122. For example, for each query for information relevant to a given document segment, the digital document generation system 110 can search the web. Alternatively, the digital document generation system 110 can search the web for a subset of queries (e.g., queries associated with publicly available information).

At 612, similar to 512, for each query for information relevant to the given document segment, the digital document generation system 110 constructs input instructions for a language generation model to generate textual content for the given document segment.

At 614, similar to 514, the digital document generation system 110 generates the digital document based on the outputs of the language generation model.

At 616, the validation engine 120 of the digital document generation system 110 validates the report generated at 614, as described with reference to FIGS. 2 and 5.

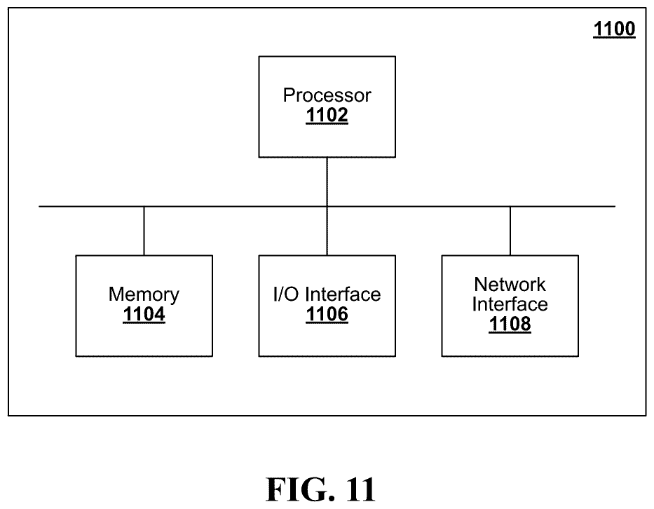

FIG. 11 is a schematic diagram of computing device 1100 which may be used to implement the digital document generation system 110, in accordance with an embodiment.

As depicted, computing device 1100 includes a processing subsystem with one or more processors 1102, one or more memories 1104, and a communication subsystem with one or more I/O interfaces 1106, and one or more network interfaces 1108.

Each processor 1102 may be, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof. Processor 1102 may, for example, include one or more central processing units (CPU), a graphics processing unit (GPU), a quantum processing unit (QPU), or the like.

Memory 1104 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each I/O interface 1106 enables computing device 1100 to interconnect with one or more input devices, such as a keyboard, mouse, camera, touch screen, and a microphone, or with one or more output devices such as a display screen and a speaker.

Each network interface 1108 enables computing device 1100 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switched telephone network (PSTN), integrated services digital network (ISDN), digital subscriber line (DSL), coaxial cable, fiber optics, satellite, mobile, wireless (e.g. Wi-Fi, WiMAX, Li-Fi), SS7 signaling network, fixed line, local area network, wide area network, and others, including any combination of these.

For simplicity only, one computing device 1100 is shown, but digital document generation system 110 may include multiple computing devices 1100. The computing devices 1100 may be the same or different types of devices. The computing devices 1100 may be connected in various ways including directly coupled, indirectly coupled via a network, and distributed over a wide geographic area and connected via a network (which may be referred to as “cloud computing”).

For example, a computing device 1100 may be a server, network appliance, set-top box, embedded device, computer expansion module, personal computer, laptop, personal data assistant, cellular telephone, smartphone device, UMPC tablets, video display terminal, gaming console, or any other computing device capable of being configured to carry out the methods described herein.

The foregoing discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer-readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which may be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

Of course, the above-described embodiments are intended to be illustrative only and in no way limiting. The described embodiments are susceptible to many modifications of form, arrangement of parts, details, and order of operation. The disclosure is intended to encompass all such modifications within its scope, as defined by the claims.

What is claimed is:

1. A computer-implemented system for generating a digital document with a defined structure, the system comprising:
a data communication subsystem that includes one or more network interfaces for receiving data by way of one or more data networks;
a processing subsystem that includes one or more processors and one or more memories coupled with the one or more processors, the processing subsystem configured to cause the system to:
receive a data structure defining a plurality of document segments;
maintain a classification model configured to classify particular documents for relevance to particular document segments;
receive a plurality of source documents, including by way of the data communication subsystem;
associate at least one class label with each of the source documents using the classification model, the class label indicating relevance to a particular document segment;
store in a vector database, a plurality of embeddings corresponding to the source documents, in accordance with their associated class labels;
for each of a plurality of queries for information relevant to a given document segment of the plurality of document segments:
submit that query to the vector database to obtain a plurality of search results from among those embeddings with class labels indicating relevance to the given document segment;
construct input instructions for a language generation model to generate textual content for the given document segment, the input instructions including the search results; and
generate the digital document using a plurality of outputs of the language generation model, the document structured to include the plurality of document segments.

2. The system of claim 1, wherein the textual content for the given document segment includes one or more citations identifying the one or more source documents associated with the search results, and the processing subsystem is configured to cause the system to:
for each segment of the generated document,
retrieve the one or more identified source documents based on the one or more class labels; and
validate the textual content of the given document segment against the one or more identified source documents using a validation model.

3. The system of claim 2, wherein the processing subsystem is configured to cause the system to:
divide a segment of the generated document into a plurality of sub-segments;
for each sub-segment, determine a sub-segment validation result; and
determine a segment validation result for the segment based on the sub-segment validation results of each of the plurality of sub-segments.

4. The system of claim 1, wherein the classification model classifies a given source document based on at least one of a content of the source document or metadata associated with the source document.

5. The system of claim 1, wherein the input instructions include a class label priority and wherein the language generation model is configured to prioritize the search results associated with the class labels indicated by the class label priority when generating textual content for the given document segment.

6. The system of claim 1, wherein the processing subsystem is configured to cause the system to receive an input indicating a type of digital document being generated and select the data structure associated with the type of document from a plurality of data structures.

7. The system of claim 6, wherein the processing subsystem is configured to cause the system to retrieve the plurality of queries based on the type of digital document generated.

8. The system of claim 1, wherein the processing subsystem is configured to cause the system to:
retrieve historical documents;
determine a historical structure for the textual content for the given document segment based on the historical documents,
and wherein the input instructions include the historical structure.

9. The system of claim 1, wherein the processing subsystem is configured to cause the system to:
identify that one or more portions of a given source document are associated with non-substantive content based on a semantic comparison between the given source document and example non-substantive content;
remove, from the given source document, the identified one or more portions to obtain a preprocessed source document; and
store in the vector database, the one or more embeddings corresponding to the preprocessed source document.

10. The system of claim 9, wherein the processing subsystem is configured to cause the system to search one or more publicly available databases to obtain one or more supplementary search results; and wherein the input instructions include the supplementary search results.

11. The system of claim 1, wherein the processing subsystem is configured to cause the system to:
receive a feedback input from a user device in communication with the system;
identify one or more segments of the digital document associated with the feedback input;
in response to receiving the feedback input, generate one or more updated input instructions based in part on the feedback input;
receive, from the language generation model, one or more updated outputs generated in response to the one or more updated input instructions; and
generate an updated digital document based on the one or more updated outputs.

12. The system of claim 11, wherein the processing subsystem is configured to cause the system to maintain a chatbot, and wherein the feedback input is received via the chatbot.

13. The system of claim 1, wherein the processing subsystem is configured to cause the system to divide at least one source document of the plurality of source documents into a plurality of data chunks, and to associate a class label with each of the data chunks using the classification model.

14. A computer-implemented method for generating a digital document with a defined structure, the method comprising:
receiving a data structure defining a plurality of document segments;
maintaining a classification model configured to classify particular documents for relevance to particular document segments;
receiving a plurality of source documents, including by way of a data communication subsystem;
associating at least one class label with each of the source documents using the classification model, the class label indicating relevance to a particular document segment;
storing in a vector database, a plurality of embeddings corresponding to the source documents, in accordance with their associated class labels;
for each of a plurality of queries for information relevant to a given document segment of the plurality of document segments:
submitting that query to the vector database to obtain a plurality of search results from among those embeddings with class labels indicating relevance to the given document segment;
constructing input instructions for a language generation model to generate textual content for the given document segment, the input instructions including the search results; and
generating the digital document using a plurality of outputs of the language generation model, the document structured to include the plurality of document segments.

15. The computer-implemented method of claim 14, wherein the content for the given document segment includes one or more citations identifying the one or more source documents associated with the search results, the method further comprising:
for each segment of the generated document,
retrieving the one or more identified source documents based on the one or more class labels; and
validating the textual content of the given document segment against the one or more identified source documents using a validation model.

16. The computer-implemented method of claim 15, further comprising:
dividing each segment of the generated document into a plurality of sub-segments;
for each sub-segment, determining a sub-segment validation result; and
determining a segment validation result for the segment based on the sub-segment validation result of each of the plurality of sub-segments.

17. The computer-implemented method of claim 14, further comprising receiving an input indicating a type of digital document being generated and selecting the data structure associated with the type of document from a plurality of data structures.

18. The computer-implemented method of claim 14, further comprising:
retrieving historical documents;
determining a historical structure for the textual content for the given document segment based on the historical documents,
and wherein the input instructions include the historical structure.

19. The computer-implemented method of claim 14, further comprising:
identifying that one or more portions of a given source document is associated with non-substantive content based on a semantic comparison between the given source document and example non-substantive content;
removing, from the given document, the identified one or more portions to generate a preprocessed source document; and
storing in the vector database, one or more embeddings corresponding to the preprocessed source document.

20. The computer-implemented method of claim 14, further comprising:
receiving a feedback input via a network, from a user device;
identifying one or more segments of the digital document associated with the feedback input;
in response to receiving the feedback input, generating one or more updated input instructions based in part on the feedback input;
receiving, from the language generation model, one or more updated outputs generated in response to the one or more updated input instructions; and
generating an updated digital document based on the one or more updated outputs.
